(19) United States
(12) Patent Application Publication
(10) Pub. No.: US 2023/0120531 A1
(43) Pub. Date: Apr. 20, 2023

(54) Inflatable Coveralls Transforms into a Chair to Lift a Fallen Person

(71) Applicants: Akanksha Aggarwal, Coralville, IA (US); Anish Aggarwal, Detroit, MI (US); Adityakumar Aggarwal, Detroit, MI (US)

(72) Inventors: Akanksha Aggarwal, Coralville, IA (US); Anish Aggarwal, Detroit, MI (US); Adityakumar Aggarwal, Detroit, MI (US)

(21) Appl. No.: 18/047,247

(22) Filed: Oct. 17, 2022

Related U.S. Application Data
(63) Continuation of application No. 16/550,268, filed on Aug. 25, 2019, now abandoned.

(51) Int. Cl. A47C 13/00; A44B 18/00; A41D 13/02; A41D 31/102; A47C 4/54; A41D 13/018; A61G 7/10

(52) U.S. Cl. CPC A47C 13/00; A44B 18/00; A41D 13/02; A41D 31/102; A47C 4/54; A41D 13/018; A61G 7/1021; A44D 2203/00; Y10S 2/03

(57) ABSTRACT

Inflatable coveralls provide individuals, who fall frequently, with protection and independence. The coveralls consist of pads on the shoulders and hips to reduce the impact of a fall on the person. When worn and located underneath the fallen person, the coveralls can be inflated with air into a chair, creating a higher platform from which the person can more easily get up. This reduces the dependence these individuals have on a caregiver. Users can fasten the coveralls using hook & loop or magnets, instead of buttons or zippers, because it is easier to wear and they automatically open from the increase in air pressure of the inflated coveralls. Made of lightweight and air-impermeable material, the inflatable coveralls pads the fall of individual and elevated the fallen individual so that they can more easily rise, allowing them to gain independence.

### CROSS-REFERENCE TO RELATED APPLICATIONS

UK Patent Application No#0112568,1 ‘Lifting Seat apparatus suitable for use in a bath’—A lifting seat apparatus suitable for raising and lowering a person in a bath comprises a seat element and a backrest or lumber support element which are formed as an integral inflatable structure.

This structure comprises two inflatables portions connected together by a joint that is flexible when the structure is deflated but becomes semi-rigid when the structure is inflated.

The structure is supported by a stack of inflatable bags which are inflated and deflated to raise and lower the structure

U.S. Pat. No. 6,161,902—STABILIZED INFLATABLE CHAIR—An inflatable chair having a Seat with front, rear, top, bottom, and opposite side portions, a back at the rear of the Seat, a pair of arm-rests at the sides of the Seat, the Seat, back and armrests defining inflatable first air chambers, a first valve for inflating the first air chambers, the bottom having front, rear, and opposite Side parts, the chair further including generally tubular inflatable Second air chambers at the front and rear and Side parts respectively of the Seat, and a Second Valve for inflating the Second air chambers independently of the first air chambers for providing a Stabilizing Support to resist tipping of said chair.

### BACKGROUND OF THE INVENTION

One of the health issues for seniors or patients suffering from muscular dystrophies, such as Kennedy Disease Syndrome (also known as Bulbo-Spinal Muscular Atrophy), is frequent falls.

These persons are not able to get up from the floor, after a fall, by themselves, due to weakness of their muscles. Such persons can have more than one fall during a week.

These falls prevent them from living by themselves.

They need another person, who can take care of them if they fall down.

There are extreme cases where seniors in cold countries have stepped out of their houses to put garbage in front of the house, slipped, failed to get up, and were frozen to death.

This invention tries to address the issue of helping seniors or people with muscular dystrophy to get up on their own if they are not severely injured.

A number of commercial products are available to help persons, who are prone to falling, to get up from the floor.

But all of the products require a caregiver to bring the lifting device to the person, who has fallen, and to help the person get up.

The caregiver is required to be with such a person all the time since there is very little advance warning about when a person, who is prone to fall, will fall.

It can happen, at any time, at home or in a park or in a parking lot or at a friend's place or in a shopping mall, or at any other place.

The Raizer is a simple battery-operated mobile lifting chair that helps up to an almost standing position within a few minutes.

Raizer can be assembled with ease.

It can be operated by only one assistant and does not require any physical effort besides a supportive hand.

The Camel Lifting Chair is designed to easily lift a fallen person. With an inbuilt backrest and internal ring construction, the Camel offers a fully supportive lift.

Using the simple hand control and compressor, which is a part of the Camel Lifting Chair, the Camel is inflated.

The Camel can be used anywhere, indoors or outside, and will lift a fallen person with dignity, while protecting both the caregiver and the person being lifted from injury.

There are a number of different industrial Hydraulic lifts for medical use for lifting persons, who are prone to fall and who cannot get up on their own, from the ground.

However, all of these lifts need caregivers to bring the lift to the person, who has fallen, for lifting them from the ground.

### Field of the Invention

### A61G 7/10

### A61G 7/1011

### A61G 7/1021

### Description of Related Art

Patent#U.S. Pat. No. 5,500,952A Hip inflatable protection device—The invention is a self-contained protective device/system designed to protect the hips, pelvis, buttocks, and coccyx areas of the user.

The device may be worn outside of the clothing.

Because it is small in size and lightweight, it may be easily put on and removed and does not interfere with body movements.

It contains the following components: an inflatable air bag folded into pleats, a battery, a gas cartridge, sensors to determine angular motion and acceleration, a triggering/valve mechanism to release the gas and a relief valve.

When the user falls, the sensors automatically release gas from the cartridge and inflate the airbag assembly, forcing the folded pleats to fully cover said areas of the user's body.

After use, the relief valve is opened to release air from the airbag assembly, the pleats are reinserted into the system and the invention is ready for reuse after the spent cartridge is replaced.

Patent#U.S. Pat. No. 4,059,852A Inflatable suit for cyclists A protective garment for minimizing impact-caused injury, primarily to the body of a motorcyclist, comprising a body-part-enclosing covering means including an effectively hollow body-part-contoured inflatable bag provided with ingress port means and exterior inflating tube means communicating the ingress port means and pressurized gas supply means and the normally closed ingress valve means relative to fixed portions of a motorcycle for forcible opening actuation of the normally closed ingress valve means upon forced abrupt separation of a motorcyclist's body from a motorcycle as a result of an accident, for causing the rapid discharge of compressed gas through the open ingress valve means, inflating tube means, and ingress port means into the inflatable bag whereby to bring about abrupt inflation thereof in a body-protecting manner.

In a preferred form, the inflating tube means is provided with controllably manually engageable and dis-engageable coupling means for allowing selective mounting and dismounting of a motorcyclist relative to a motorcycle without causing the forced opening of the ingress valve means and the consequent abrupt inflation of the inflatable bag.

Patent #U.S. Pat. No. 3,895,396A Expandable protective device A lightweight multi-cell sheet-like protective device that in a preferred embodiment is worn in a compact rolled donut-shaped configuration about the waist of the user and is so maintained by spring means that form a part of the device.

Manually operable compressed gas or air supply means are also included as a part of the device.

Upon an emergency arising, the supply means are manually actuated to inflate the cells, with the device then inflating from the first position to cover all or a desired portion of the user's body to protect the user from a sudden shock or other changes of the environment that would be detrimental to him.

### BRIEF SUMMARY OF THE INVENTION

This invention is an inflatable coveralls, is made of light-weight air-impermeable material, and coveralls is attached to inflating devices to transform the coveralls into a chair as shown in FIGS. 3(a), 3(b),4(a), and 4(b) without four legs. Typically, a large volume of air is needed to inflate the whole of the coveralls into a chair. In other embodiments, a designer can give a good shape to coveralls, instead of the baggy-fitting inflatable, by making parts of coveralls stretchable while keeping other parts of coveralls not-inflatable. But all such designs must lead to a chair when the coveralls is inflated.

The design of the inflatable coveralls is such that when it is inflated: a) the pants part of the coveralls [1019] & [1007] inflate and they transform into the seat—[3002], [4003], [4004],—of the chair, b) the shirt part −[1006]—of the coveralls inflate and transforms into the chair backrest −[3001], and c) in one of the embodiments sleeves [3006] of the coveralls transforms into the armrest, [3009] [4009]. When the coveralls is inflated, it transforms into a chair under the fallen person on the ground/floor which helps to raise the person who cannot get up on their own.

An inflatable coverall consists of one or more layers of wearable flexible material where at least one layer is made up of air-impermeable material. This coverall can be covered by fabric that is comfortable to wear. In short, inflatable coveralls is made up of one or more layers (a) the inner layer [1021] made of air-impermeable material which is also referred to as an inner layer, and (b) the outer layer [1022] made of fabric that is comfortable to wear—which is also referred to as the outer layer. This fabric can also provide strength to the air-impermeable material so it doesn't burst when air is filled with significant pressure due to the weight of the person lying on the coveralls. In another embodiment, coveralls can be made of only one layer of impermeable material which is also comfortable to wear. Similarly, in yet another embodiment, the coveralls implementation can be made of more than two layers, where at least one layer is made of air-impermeable material to allow the inflatable coveralls to transform into the chair.

Coveralls are fastened through hook & loop or magnetic fasteners which a person uses to tie the inflatable coveralls when worn, and these fasteners are such that they untie the coveralls automatically due to air pressure without tearing the coveralls when the coveralls is inflated to transform into a chair.

This facilitates the user to wear the coveralls easily by using a hook and loop or magnetic fasteners.

In one of the embodiments to wear coveralls easily, wearers can use suspenders as shown by [1001] and [1017] in FIG. 1 and [2001] and [2010] in FIG. 2. Also, one of the possible ways of wearing the coveralls is shown by the arrows in FIG. 2.

This is not the only process for putting on the coveralls as it depends on the mobility of the person wearing the coveralls.

The hook & loop or magnet fasteners are untied automatically due to air pressure when coveralls are inflated. The hook and loop or magnets hold coveralls around the fallen wearer while the coveralls are getting inflated. Also, in the beginning, the air is filled more in areas not under the fallen wearer as there is no weight of the fallen wearer in those areas. This creates a cocoon around the wearer and as the air gets filled in coveralls the coveralls starts forming a chair and lifts the fallen wearer.

The coveralls has pads around the hips and shoulders to reduce the impact of a fall on the person.

Inflation devices will be placed at the ankles, where there is the minimal impact upon falls.

Inflation devices can either be air pumps in one embodiment or use compressed air canisters or use chemicals, which produce gas when a chemical reaction is triggered. There is a significant amount of air required to be filled in coveralls to convert it to a chair. As a result, it takes time of tens of minutes to fill the air in the coveralls to transform into the chair.

The technique of using chemicals for producing gas is also used in airbags in vehicles. If a very large amount of air is tried to be filled in sub-seconds into the coveralls it could give a shock to the wearer besides the shock of falling down and in some cases, it would lead to an injury similar to injuries to children in vehicles during the deployment of airbags. So, unlike an auto, the air is generated slowly in the coveralls taking minutes to fill the gas.

The inflation devices can be triggered manually by the person who has fallen.

The triggering device can be smart devices such as smartwatches or smartphones or Google Home or Amazon Echo with voice recognition technologies. These smart devices integrate with inflation devices using various wireless technologies such as BlueTooth, Z-wave, WiFi, etc

The triggering device can be automatically triggered when a person is falling if smart devices such as smartwatches (e.g. Apple Watch) or smartphones are able to detect the fall of the person.

As the coverall is inflated and transformed into a chair, it makes it easy for the person, who has fallen, to independently get up from the higher surface of the chair, created by air-ingress into the chambers, built in the coveralls.

### BRIEF DESCRIPTION OF THE SEVERAL VIEWS OF THE DRAWINGS

FIG. 1 is the front view of the coveralls, which will be placed on the back of the person.

FIG. 2 is similar to FIG. 1, but it demonstrates by arrows how the coverall can be worn by the person. This is one of the ways the coveralls can be worn but it can change based on the mobility of the wearer.

FIG. 3(a) is the right-side view of the inflated coverall as a chair.

FIG. 4(a) is the front view of the inflated coverall as a chair.

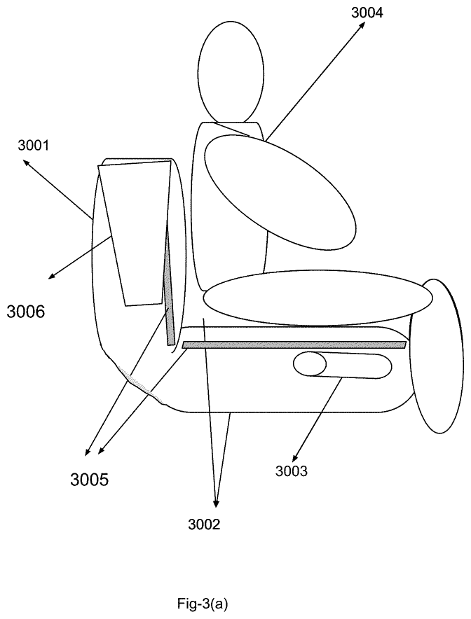

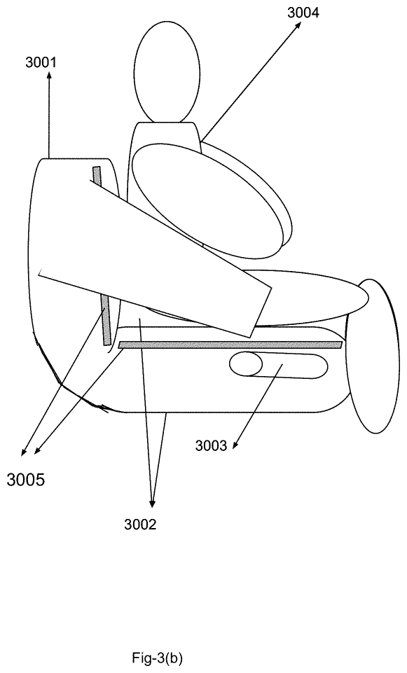

FIG. 3(b) is the right-side view of the inflated coverall as a chair with armrest.

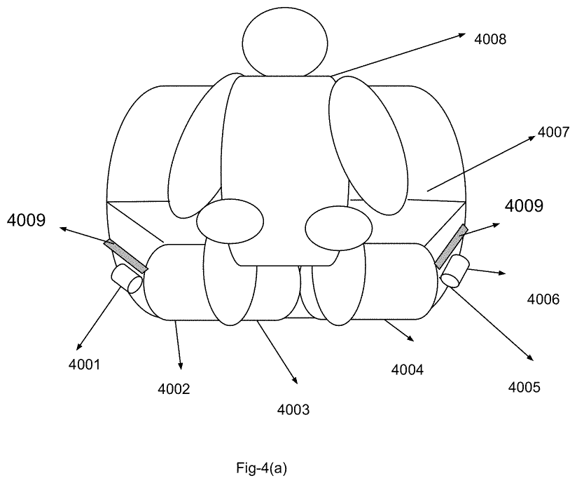

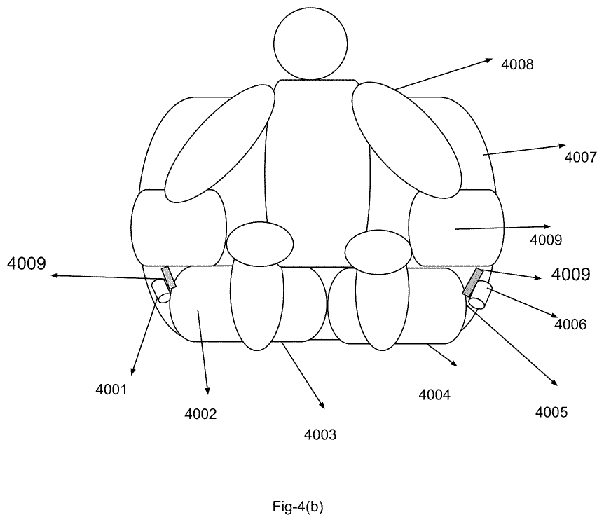

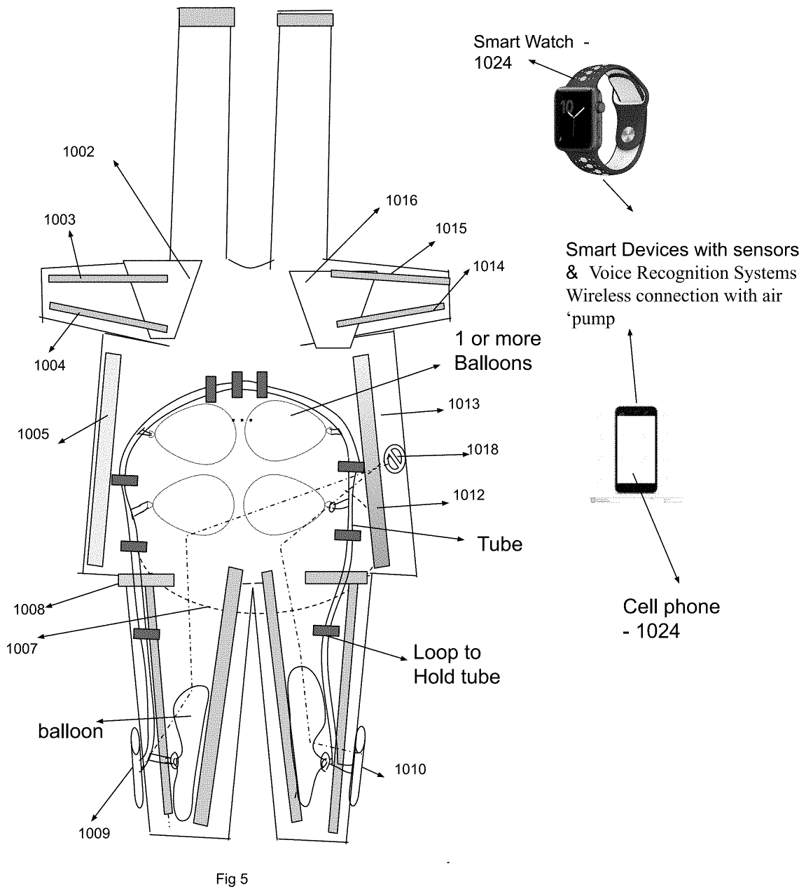

FIG. 4(b) is the front view of the inflated coverall as a chair with armrest

FIG. 5 is the front view of the coveralls using balloons as an air-impermeable material.

Each figure shows a different aspect of the same coveralls instead of showing all in one diagram so it becomes easy to read and understand.

### DETAILED DESCRIPTION OF THE INVENTION

An inflatable coverall is designed for use by seniors or persons, who frequently fall down and cannot get up from the floor themselves.

An inflatable coveralls comprising (i) one or more layers of wearable flexible material where at least one layer is made up of air-impermeable material, a outermost layer of the inflatable coverall is referred to as an outer layer [2007], (ii) one or more air chambers that are formed when the coveralls are inflated, (iii) fasteners, which a person uses to tie the inflatable coveralls, and which untie automatically, due to air pressure without tearing the coveralls during inflation of the coveralls, (iv) pads at hips and shoulder areas to reduce an impact of a fall, (v) inflation devices to inflate the coveralls, which are configured to transform into a chair with a seat and backrest to help the person, who, after falling on a floor cannot get up by themselves, (vi) triggering device for the inflation devices to inflate the coveralls, (v) pants [1019], suspenders [1001] [1017], and shirt [1013] with sleeves [1020], whereby the inflatable coveralls are designed to transform the pants [1019] of the coveralls to form the seat, to transform the shirt of the coveralls into a backrest of the chair, thereby transforming the coveralls into the chair, when inflated, to enable the person, who has fallen on the floor, to get up on their own.

One of the ways coveralls can be put on by the person as shown by FIG. 2 and in the direction pointed by the arrows and presented by following steps (a) putting the coveralls by putting first on the back and bringing the suspenders—[2001] & [2010] in the front and tying it to the waist—[2002] & [2006] of the pants part of the coveralls by wrapping around the legs as shown. (b) complete the wrapping around the legs [2003] as shown in FIG. 2 by the arrows. (c) Then wrap the shirt part of the coveralls as shown in FIG. 2 by the arrows. (d) Then wrapping the sleeves of the coverall around the arms [2008].

This is not the only method for putting on the coveralls as it depends on the mobility of the person wearing the coveralls.

If such a person is wearing the coveralls, when they fall, the coveralls is configured to be transformed into a chair, through inflation. It helps them to get up on their own, without the help of a caregiver.

A method of inflation of the coveralls is as follows: (a) When the inflation devices are triggered, the air starts to fill in the inflatable coveralls. The process is very similar to inflation of air mattress with an air pump while a person is lying on it (b) In the beginning hook and loop [4009] or magnets [4009] hold coveralls around the fallen wearer while the coveralls are getting inflated. Also, in the beginning, the air is filled more in areas not under the fallen wearer as there is no weight of the fallen wearer in those areas. This creates a cocoon around the wearer. (c) As more and more air is filled in and pressure increases the hook & loop or magnet fasteners [3005] are untied automatically due to air pressure (d) The air gets filled in the inflatable coveralls to form air chambers. (e) Slowly the inflatable coveralls is transformed into an air-filled chair and becomes firm and also lifts the fallen person up in the chair. (f) Then the person gets up from the chair and stops the inflation device by switching off the triggering switch.

A method of inflation of inflatable coveralls is similar to manually triggered battery-powered air pumps used for inflating air-beds, pillows, and tires of the vehicles.

It includes one or more inflation devices to inflate the coveralls into a chair from which the person, who has fallen, can get up easily.

The shape of chair will depend on the elasticity of the layers of flexible wearable material used in building the inflatable coveralls as well as the shape of the coverall once it is inflated.

The shape of the coveralls especially the air-impermeable layer is such that when it inflates it transforms into the shape of the chair.

The shape of chair that is very simple and it consists of (a) seat like a air mattress formed by inflation of pants part of the coveralls (b) backrest formed by the inflation of the shirt part of the coveralls. Hip pad [1011] acts as a brace to hold the back rest and seat together at close to right angle.

The air pressure inside the inflatable coverall converts coveralls to a rigid chair structure to support the weight of the wearer similar to when the air is filled in the tire of the automobile to form a rigid structure to support the weight of the vehicle.

Due to the large amount of air required to be filled as well as to not prevent further injury to the person the air is filled in the coveralls over a period of tens of minutes instead of filling in the coveralls in sub-sec.

The coveralls are expected to be worn regularly by persons, who are prone to falls.

To facilitate easier wearing, the coveralls with, [1001], [1017], [2002], [2010], use hook and loop or magnets, [1003], [1004], [1005], [1008], [1012], [1014], [1015], [2001], 2011], [2006], as fasteners, instead of buttons or zippers.

Secondly, the hook & loop and magnetic fasteners are made such that they untie the coveralls automatically, due to air pressure without tearing the coverall, when the coveralls is inflated, to transform it into a chair.

To make the coveralls comfortable for the wearer, the outer layer can be made of breathable material such as cotton for summer. The outer layer further provides strength to the inner layer against rupture and protection against puncture.

The inflatable coveralls has an outer layer, which in another embodiment, is made of water-proof material such as plastic, rubber & nylon for outdoor use during rain.

For use when it is winter, the outer layer is made of material that keeps the person warm for outdoor use during winter.

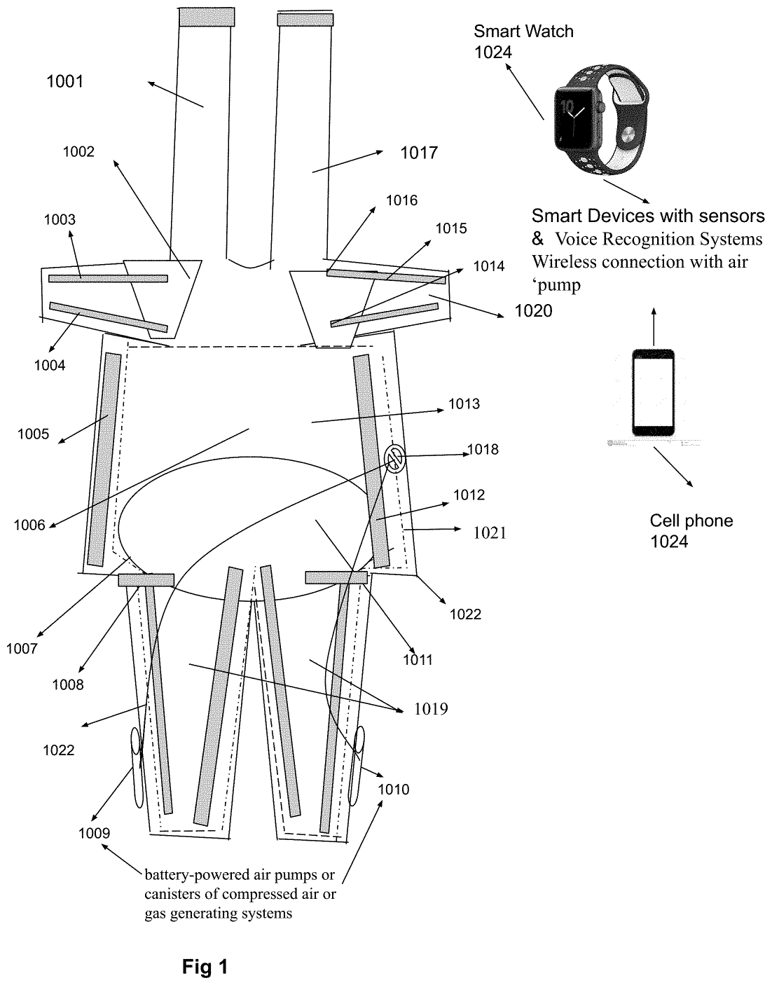

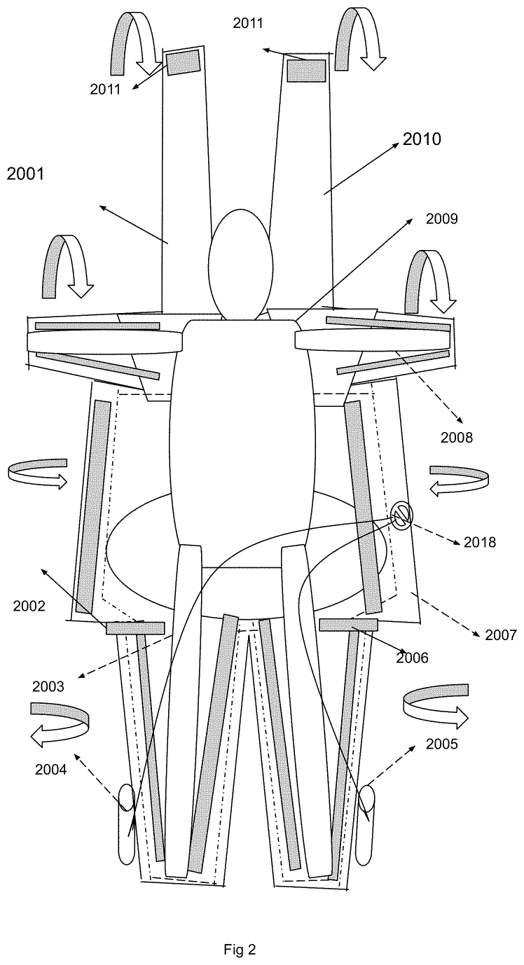

The coveralls as seen in FIGS. 1 and 2, are made of air-impermeable light-weight material, also referred to as the inner layer, which is covered in comfortable wearable fabric, also referred to as the outer layer, to support daily use.

Coveralls have pads on the shoulders [1002] and [1016] and hips [1011] to reduce the impact upon hitting the ground.

In addition, coveralls use hook & loop or magnetic fasteners, [1003], [1004], [1005], [1008], [1012], [1014], and [1015] so that a senior or a patient can easily fasten the coveralls, without any assistance.

Hook & Loop and magnetic fasteners are easy to unfasten when the coveralls are inflated.

The triggering devices can be designed to trigger inflation devices to inflate even as the person starts falling.

This will provide a cushion for reducing the adverse impact of the fall on the wearer of the coveralls.

The wearer of the coveralls, who has fallen, needs to quickly rotate themself into the supine position so that they are lying on their back.

The person—[2009] manually activates, by pressing a switch [1018] & 2018, the inflation devices such as small lightweight battery-powered air pumps, compressed air canisters, or a chemical reaction to generate gas. In the manual process, the triggering device is a switch that is connected by wire [1022].

The battery is already there in battery-powered air pumps so no additional battery is needed in the switch but a battery will be needed in the switch to open the compressed air canister or to trigger a chemical reaction to generate the gas.

In other embodiments, it could be a wireless or WiFi connection instead of a wired connection.

Inflation devices [1009], [1010], [2004], [2005], [3003], [4001], and [4006] are placed at the ankles to inflate the coverall into the shape of a chair.

When the coveralls is inflated, coveralls comes-off the wearer is transformed into a chair.

The chair will have one or more chambers [3001], [3002], [4002], [4005], and [4007], which can be filled with air to raise the individual [3004] and [4008], in one embodiment, to balance the individual on the chair, which has inflated armrests [4009].

On inflation, the coveralls get transformed into a chair as it lifts the wearer up from the floor.

Once the coveralls is inflated into a chair, the person gets up from the chair.

The chair can be deflated and worn back as coveralls.

The inflation devices can be removed from the coveralls for cleaning of coveralls or for other reasons such as putting on other coveralls or for charging batteries.

The outer layer of the coveralls can be made of various materials depending on their use e.g. woolen material for winter coats, cotton fabric for summer weather, and weather-resistant material for snow and rain.

So a person can have multiple outer layers for one inflatable coveralls and change the outer layer of the coveralls based on weather conditions or use e.g. going out shopping to clean or to put the already worn outer layer for wash as it has become dirty.

The outer layer of the coveralls can be removed and cleaned by various methods depending on the type of material of the outer layer. After cleaning the outer layer is put back on the coveralls.

In another embodiment, the triggering of the inflation devices will be integrated smart devices [1024] such as iPhone or iWatch or other similar devices which are worn by the person.

These smart devices have integrated sensors for detecting falls automatically and triggering inflations of the coveralls.

Smart devices can be connected using Internet of Things (IoT) protocols with the inflation devices.

This will reduce the impact, as well as contact with the local emergency departments.

Coveralls inflation system can be integrated with smart devices such as smartphones or smart watches as IoT devices and then can be voice-enabled to trigger inflation of inflatable coveralls as well as allow automatic connection to 911 or emergency contacts or services. Various protocols such as BlueTooth, Wifi, Z-Wave, ZigBee, NFC, and even RFID-based technologies can be used to integrate with the triggering devices.

The coveralls is designed to help the elderly live independently and get up on their own after a fall.

The air-impermeable material layer in one embodiment of the invention is made up of balloons, which form air chambers when inflated, and which are connected by a flexible tube.

The advantage of this method is that as balloons deflate into smaller sizes, the coveralls could be completely breathable and more comfortable to wear.

The number of balloons used will depend on the size of the coveralls and the size of the balloons.

A flexible tube or multiple tubes will be used to connect all the balloons.

The disadvantage of using balloons is that more powerful inflation devices will be needed to push air into the balloons and to inflate coveralls into a chair.

Although the present invention has been described in conjunction with one preferred embodiment, it is to be understood that modifications and variations may be resorted to without departing from the spirit and the scope of the invention, as those skilled in the art will readily understand.

1. An inflatable coveralls comprising
(i) one or more layers of wearable flexible material where at least one layer is made up of air-impermeable material, a outermost layer of the inflatable coverall is referred to as an outer layer,
(ii) one or more air chambers that are formed when the coveralls are inflated,
(iii) fasteners, which a person uses to tie the inflatable coveralls, and which untie automatically, due to air pressure without tearing the coveralls during inflation of the coveralls,
(iv) pads at hips and shoulder areas to reduce an impact of a fall,
(v) inflation devices to inflate the coveralls, which are configured to transform into a chair with a seat and backrest to help the person, who, after falling on a floor cannot get up by themselves,
(vi) triggering device for the inflation devices to inflate the coveralls,
(v) pants, suspenders, and shirt with sleeves,
whereby the inflatable coveralls are designed to transform the pants of the coveralls to form the seat, to transform the shirt of the coveralls into a backrest of the chair, thereby transforming the coveralls into the chair, when inflated, to enable the person, who has fallen on the floor, to get up on their own.

2. The inflatable coveralls, of claim 1, has the inflation devices, which in one embodiment, are battery-powered air pumps to inflate the coveralls configured to transform into the chair.

3. The inflatable coveralls, of claim 1, has the inflation devices, which in another embodiment are canisters of compressed air to inflate the coveralls, configured to transform into the chair.

4. The inflatable coveralls, of claim 1, has the inflation devices, which in another embodiment are gas-generating systems through a chemical reaction to inflate the coveralls configured to transform into the chair.

5. The inflatable coveralls, of claim 1, has the triggering devices, which in one embodiment, are configured to trigger to inflate the coveralls by a smartwatch or a smart device, which can detect the fall of the person, who is wearing the inflatable coveralls configured to transform into the chair when inflated.

6. The inflatable coveralls, of claim 1, has the triggering devices, which in another embodiment are configured to trigger by a smart device voice recognition system to inflate the coveralls configured to transform into the chair.

7. The inflatable coveralls, of claim 1, has the sleeves, which in another embodiment, are configured to inflate into armrests of the chair.

8. The inflatable coveralls, of claim 1, has the outer layer, which in one embodiment, is made of breathable material for summer.

9. The inflatable coveralls, of claim 1, has the outer layer, which in another embodiment, is made of water-proof material for outdoor use during rain.

10. The inflatable coveralls, of claim 8, has the outer layer, which in another embodiment, is made of material that keeps the person warm for outdoor use during winter.

11. In the inflatable coveralls, of claim 1, the air-impermeable material layer in one embodiment of the invention, is made up of balloons, which form air chambers when inflated, and which are connected by a flexible tube.

12. In the wearable and inflatable coveralls, of claim 1, the fasteners in one embodiment, are magnets.

13. In the inflatable coveralls, of claim 1, the fasteners in another embodiment, are hook and loop fasteners.

14. In the inflatable coveralls, of claim 1, in another embodiment, the triggering device, is a manually initiated switch to inflate the coveralls to transform them into the chair.

15. A method for using an inflatable coveralls comprises
(a) putting on the inflatable coveralls as daily wear by a person, by attaching devices for inflating the coveralls, and by using fasteners to fasten up the inflatable coveralls,
(b) in case of a fall of the person, who is wearing the inflatable coveralls, rotates themself into the supine position, so that they are lying on their back,
(c) triggering manually through a switch or voice activation or automatically through sensors in smart devices worn by the person, the inflation devices inflate the coveralls, which is configured to transform into a chair when inflated,
(d) automatically untying of fasteners due to pressure created by inflation of the inflatable coveralls,
(e) inflating coveralls, which come off the person and transforms into a chair under the person, thereby enabling the person to get up on their own,
(f) deflating the chair and wearing back the coveralls, after the person has got up after the fall,
(g) removing the inflation devices for charging batteries, when the coveralls are not being used,
(h) removing the outer layer from the multi-layer inflatable coveralls for cleaning or replacing it with another outer layer before wearing it again.
